(19) United States
(12) Patent Application Publication
(10) Pub. No.: US 2006/0007034 A1
(43) Pub. Date: Jan. 12, 2006

(54) Composite radar absorption structure with a thin shell type and method for manufacturing the same

(76) Inventors: Wen-Jang Yen, Shalu Township (TW); Abel Yu, Taichung City (TW); Ken-Chang Tien, Changhua City (TW); Yuan-Chang Chang, Daya Township (TW)

Correspondence Address: J C PATENTS, INC., 4 VENTURE, SUITE 250, IRVINE, CA, 92618, US

(21) Appl. No.: 10/886,982

(22) Filed: Jul. 7, 2004

(51) Int. Cl. H01Q 17/00

(52) U.S. Cl. 342/1; 342/4

(57) ABSTRACT

A composite radar absorption structure with a thin shell type and a method for manufacturing the same are provided. The composite radar absorption structure at lease comprising a continuous fibrous material and a plurality of filling mediums, wherein the plurality of filling mediums are uniformly distributed over the surface perpendicular to the thickness direction in the continuous fibrous material; and a volume percentage of the plurality of filling mediums are between 10 vol. % and 25 vol. % of the continuous fibrous material.

### BACKGROUND OF THE INVENTION

1. Field of the Invention

This invention generally relates to a composite radar absorption structure and a method for manufacturing the same, and more particularly to a composite radar absorption structure with a thin shell type and a method for manufacturing the same.

2. Description of Related Art

Currently, most electromagnetic wave absorption materials are made from carbonyl iron, ferrite or black carbon added into polymer base such as neoprene or epoxy. Such materials have to be adhered on the surface of a structure because the strength of the materials is below the structure requirements. Nevertheless, the profile and the weight of origins design would be changed due to the above action.

Thus, U.S. Pat. No. 4,581,284 (Inventors: Klaus Eggert et al.) discloses a fiber compound material of individual layers of superposed fiber plies such as glass fiber prepregs which are joined together by a matrix of a resin and a hardener and act as a load carrying structure to absorb electromagnetic waves. Radar beam-absorbing fillers, for instance iron powder or soot, are included, in concentrations varying from the outside to the inside, in the individual plies of the fiber compound material.

However, it still has structure issue because the total thickness of the fiber compound material in U.S. Pat. No. 4,581,284 is too thick to solve structural problem perfectly.

### SUMMARY OF THE INVENTION

An object of the present invention is to provide a composite radar absorption structure with a thin shell type to provide excellent electromagnetic wave absorption with less thickness and to be employed as the primary structure or the secondary structure. The main function of the thin shell is to absorb the certain frequency region of the electromagnetic wave to reduce the radar cross section.

Another object of the present invention is to provide a method for manufacturing a composite radar absorption structure with a thin shell type to simplify the process and to manufacture a wave absorption structure with a high volume percentage of filling medium.

The present invention provides a composite radar absorption structure with a thin shell type, at lease comprising a epoxy resin reinforcement with continuous fibrous material and a plurality of filling mediums, wherein the plurality of filling mediums are uniformly distributed over the surface perpendicular to the thickness direction in the continuous fibrous material; and a volume percentage of the plurality of filling mediums are between 10 vol. % and 25 vol. % of the continuous fibrous material.

The present invention provides a method for manufacturing a composite radar absorption structure with a thin shell type, comprising: (a) providing a continuous fibrous pre-preg base; (b) spraying a plurality of filling mediums, an amount being smaller than a specified amount onto the continuous fibrous pre-preg base with moderate temperature; and (c) repeating the step of (b) until the amount of the plurality of filling mediums reaches the specified amount.

Because the present invention sprays the filling medium with electrical and magnetic characteristics into the continuous fibrous pre-preg base by several times, a large amount of the filling medium are added into the continuous fibrous pre-preg base.

In addition, because the present invention employs the continuous fiber as the substrate, the composite radar absorption structure with thin shell can provide excellent electromagnetic wave absorption characteristics and excellent strength used as the primary structure or the secondary structure.

Further, the composite radar absorption structure with a thin shell type has a high specific-strength and anti-corrosion. Hence, it has a long lifetime to decrease any maintenance problem.

Still further, because the composite radar absorption structure with a thin shell type has a large amount of the filling medium uniformly distributed over the surface perpendicular to the thickness in the continuous fibrous pre-preg base, an excellent electromagnetic wave absorption characteristic can be achieved with less thickness. Hence, the main function of the thin shell is to absorb the certain frequency region of the electromagnetic wave to reduce the radar cross section.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF THE DRAWINGS

FIG. 1 shows the process for manufacturing a composite radar absorption structure with a thin shell type in accordance with a preferred embodiment of the present invention.

FIG. 2 is a structural view of a composite radar absorption structure.

FIG. 3 shows the relationship of the reflection loss and the frequency of the composite radar absorption structure with a thin shell type in accordance with a preferred embodiment of the present invention.

### DESCRIPTION OF THE PREFERRED EMBODIMENTS

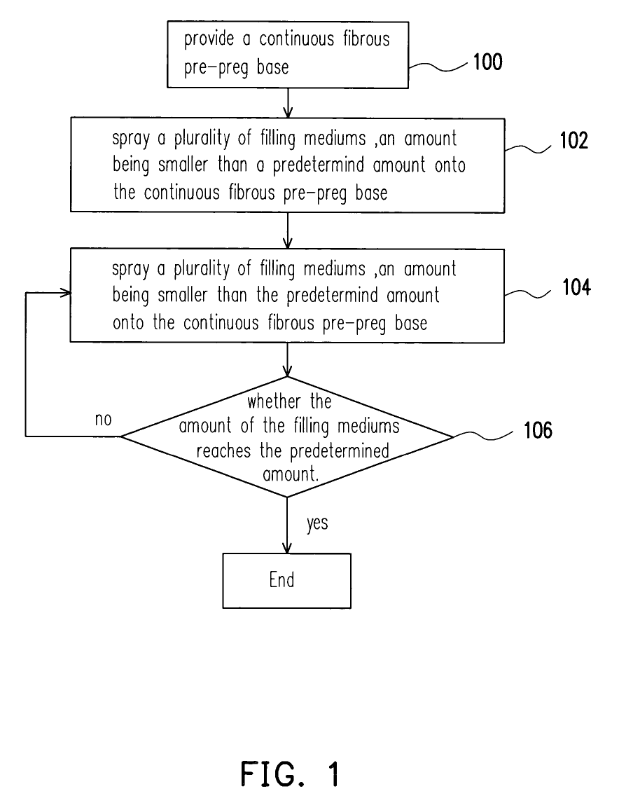

FIG. 1 shows the process for manufacturing a composite radar absorption structure with a thin shell type in accordance with a preferred embodiment of the present invention. Referring to FIG. 1, the step 100 is providing a continuous fibrous pre-preg base, wherein said continuous fibrous pre-preg base includes one of a fiber glass pre-preg base, an aramid pre-preg base, and a quartz pre-preg base.

The step 102 is spraying a plurality of filling mediums, an amount being smaller than a predetermined amount onto the continuous fibrous pre-preg base with moderate temperature. The filling mediums have electrical and magnetic characteristics and the type and amount of the filling mediums depend on the characteristics of the absorbed electromagnetic wave. The predetermined amount depends on the total amount of the filling mediums, e.g., between 10 vol. % and 25 vol. % of said continuous fibrous pre-preg base. The filling mediums at least include one of Fe₃C, BaTiO₃, ferrite, and a composite thereof.

Because a large amount of filling mediums is added into the continuous fibrous pre-preg base, the filling mediums should be added by several times. Then the step 104 is spraying a plurality of filling mediums, an amount being smaller than the predetermined amount onto the continuous fibrous pre-preg base.

The step 106 is determining whether the amount of the filling mediums reaches the predetermined amount. If so, the process is complete. If not, then the step 104 is repeated until the amount of the filling mediums reaches the predetermined amount. In addition, the amount of the filling mediums can be controlled based on the gross weight of the continuous fibrous pre-preg base so that the tolerable deviation can be less than 1. Because the step 106 can be estimated in advance, it is not a must step.

In addition, after the steps in FIG. 1, the process further comprising: folding said continuous fibrous pre-preg base with said plurality of filling mediums to be a thin structure. A number of layers of the thin structure can be attached to the mold of the structure. Then the next step is providing a non-woven polyester felt absorbing layer on said thin structure; sealing with vacuum bag in sequenced; then increasing a pressure and a temperature for molding in autoclave. In the molding process, the critical parameters are the thickness of the non-woven polyester felt layer, the pressure applied, and the amount of the resin absorbed. By fine-tuning these parameters, the best quality of wave absorption efficiency can be obtained.

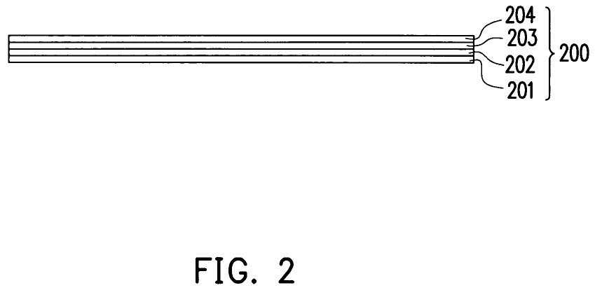

FIG. 2 is a structural view of a composite radar absorption structure. Referring to FIG. 2, the structure 200 of the present invention includes the continuous fibrous materials 201, 202, 204, and 204. The composite radar absorption structure 200 at least includes a plurality of filling mediums. The continuous fibrous materials comprise a reinforcement material and a substrate; said reinforcement material includes one of a glass fiber, an aramid, and a quartz fiber, and said substrate includes an epoxy. The filling mediums at least include one of Fe₃C, BaTiO₃, ferrite, and a composite thereof. The filling mediums are uniformly distributed over the surface perpendicular to the thickness in said continuous fibrous materials 201, 202, 204, and 204; and a volume percentage of said plurality of filling mediums are between 10 vol. % and 25 vol. % of said continuous fibrous materials 201, 202, 204, and 204. Although the structure 200 consists of four layers of continuous fibrous materials 201, 202, 204, and 204, the number of the layers of the composite radar absorption structure 200 can be changed as needed, which depends on the wave absorption characteristics of the electromagnetic waves and the required structural strength and is not limited to four layers as shown in FIG. 4. I.e., the composite radar absorption structure is a laminated continuous fibrous material based on the design requirement. In addition, said composite radar absorption structure absorbs an electromagnetic wave with a frequency between 0.5 GHz to 20 GHz; said composite radar absorption structure has a thickness between 0.5 mm to 5 mm.

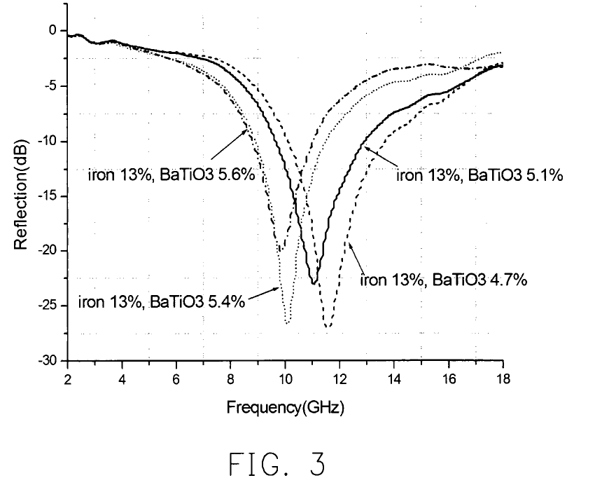

The performance of the composite radar absorption structure of the present invention is shown in FIG. 3. FIG. 3 shows the relationship of the reflection loss and the frequency of the composite radar absorption structure with a thin shell type in accordance with a preferred embodiment of the present invention. The continuous fibrous material is the glass fiber and the filling mediums include the iron powder (13%) and BaTiO₃ (3-6%). As shown in FIG. 3, the reflection of electromagnetic wave at frequency of 10 GHz provided by the structure of the present invention is more than −25 dB. The composite radar absorption structure has a thickness of 1.5 mm in this embodiment. Hence, the present invention can be applied on the outer wall of the structure and the shell of the device to absorb the electromagnetic waves with a certain frequency to avoid electromagnetic interference.

In light of the above, the present invention has the following characteristics:

1. Because the present invention fills the filling medium having electrical and magnetic characteristics into the continuous fibrous pre-preg base by several times, a large amount of the filling medium will be uniformly distributed over the surface perpendicular to the thickness in the continuous fibrous pre-preg base.

2. Because the present invention adopts the continuous fiber as the substrate, the composite radar absorption structure can provide excellent electromagnetic wave absorption and be used as the primary structure or the secondary structure.

3. Because the filling medium is uniformly distributed over the surface perpendicular to the thickness in the continuous fibrous pre-preg base, an excellent ability to electromagnetic wave absorption can be achieved with less thickness.

4. The composite radar absorption structure with a thin shell type of the present invention has a high specific-strength and anti-corrosion. Hence, it has a long lifetime to decrease any maintenance problem.

5. The present invention can be applied on the outer wall of the structure and the shell of the device to absorb the electromagnetic waves with a certain frequency to avoid electromagnetic interference.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A method for manufacturing a composite radar absorption structure with a thin shell type, comprising:
(a) providing a continuous fibrous pre-preg base;
(b) spraying a plurality of filling mediums, an amount being smaller than a predetermined amount onto said continuous fibrous pre-preg base; and
(c) repeating said step of (b) until said amount of said plurality of filling mediums reaches said specified amount.

2. The method of claim 1, wherein said continuous fibrous pre-preg base is one of a fiber glass pre-preg base, an aramid pre-preg base, and a quartz pre-preg base.

3. The method of claim 1, wherein said plurality of filling mediums at least include one of Fe₃C, BaTiO₃, ferrite, and a composite thereof.

4. The method of claim 1, wherein said predetermined amount is between 10 vol. % and 25 vol. % of said continuous fibrous pre-preg base.

5. The method of claim 1, after said step (c), further comprising:
folding said continuous fibrous pre-preg base with said plurality of filling mediums to be a thin structure;
providing a non-woven polyester felt absorbing layer on said thin structure;
sealing with vacuum bag; and
increasing a pressure and a temperature for molding in autoclave.

6. A composite radar absorption structure with a thin shell type, at lease comprising a epoxy resin reinforcement with continuous fibrous material and a plurality of filling mediums, wherein
said plurality of filling mediums are uniformly distributed over the surface perpendicular to the thickness in said continuous fibrous material; and
a volume percentage of said plurality of filling mediums are between 10 vol. % and 25 vol. % of said continuous fibrous material.

7. The composite radar absorption structure of claim 6, wherein said continuous fibrous material comprises a reinforcement material and a substrate, said reinforcement material includes one of a glass fiber, an aramid, and a quartz fiber, and said substrate includes an epoxy.

8. The composite radar absorption structure of claim 6, wherein said plurality of filling mediums at least include one of Fe₃C, BaTiO₃, ferrite, and a composite thereof.

9. The composite radar absorption structure of claim 6, wherein said composite radar absorption structure absorbs an electromagnetic wave with a frequency between 0.5 GHz to 20 GHz.

10. The composite radar absorption structure of claim 9, wherein said composite radar absorption structure has a thickness between 0.5 mm to 5 mm.
